(19) United States
(12) Patent Application Publication
(10) Pub. No.: US 2018/0345979 A1
(43) Pub. Date: Dec. 6, 2018

(54) ROAD ROUGHNESS CLASSIFICATION

(71) Applicant: GM Global Technology Operations LLC, Detroit, MI (US)

(72) Inventors: Amin Abdossalami, Toronto (CA); Robin Chin, New Hudson, MI (US); Marcus-Andre Reul, Nauheim (DE)

(21) Appl. No.: 15/609,552

(22) Filed: May 31, 2017

(51) Int. Cl. B60W 40/06; G06K 9/00; B60G 17/0165; B60G 17/0195; G01C 7/04

(52) U.S. Cl. CPC B60W 40/06; G06K 9/00791; B60T 2210/10; B60G 17/0195; G01C 7/04; B60G 17/0165

(57) ABSTRACT

Examples of techniques for classifying roughness of a road are disclosed. In one example implementation, a method includes performing a first temporal analysis based at least in part on a speed of each of a plurality of wheels of a vehicle. The method further includes performing a second temporal analysis based at least in part on a combined wheel speed of the plurality of wheels. The method further includes performing a frequency analysis based at least in part on the speed of each of the plurality of wheels of the vehicle. The method further includes classifying the roughness of the road based at least in part on the first temporal analysis, the second temporal analysis, and the frequency analysis.

### INTRODUCTION

The present disclosure relates generally to classifying road roughness and more particularly to classifying road roughness using temporal and frequency based techniques.

A vehicle, such a car, motorcycle, or any other type of automobile may be equipped with a suspension control system to alter characteristics of the suspension of the vehicle. For example, a suspension control system can include a coil spring and a shock absorber. The spring constant of the coil spring and/or the damping force of the shock absorber can be controlled to adjust the suspension of the vehicle. This may be useful to increase ride comfort, maneuverability, safety, efficiency, and other properties of the vehicle.

### SUMMARY

In one exemplary embodiment, a computer-implemented method for classifying roughness of a road includes performing a first temporal analysis based at least in part on a speed of each of a plurality of wheels of a vehicle. The method further includes performing a second temporal analysis based at least in part on a combined wheel speed of the plurality of wheels. The method further includes performing a frequency analysis based at least in part on the speed of each of the plurality of wheels of the vehicle. The method further includes classifying the roughness of the road based at least in part on the first temporal analysis, the second temporal analysis, and the frequency analysis.

In some examples, performing the first temporal analysis is further based at least in part on longitudinal acceleration data for the vehicle. In some examples, performing the second temporal analysis is further based at least in part on an angular acceleration dispersion of the vehicle. In some examples, performing the second temporal analysis is further based at least in part on a filtered angular dispersion of the vehicle wheels. In some examples, performing the frequency analysis further comprises applying a fast Fourier transform. An example method may additionally include receiving the speed of each of the plurality of wheels from a sensor coupled to each of the plurality of wheels. An example method may additionally include calculating the combined wheel speed of the plurality of wheels based at least in part on the speed of each of the plurality of wheels of the vehicle. An example method may additionally include adjusting a suspension of the vehicle based at least in part on classifying the roughness of the road.

In another exemplary embodiment, a system for classifying roughness of a road includes a memory including computer readable instructions and a processing device for executing the computer readable instructions for performing a method. In examples, the method includes performing a first temporal analysis based at least in part on a speed of each of a plurality of wheels of a vehicle. The method further includes performing a second temporal analysis based at least in part on a combined wheel speed of the plurality of wheels. The method further includes performing a frequency analysis based at least in part on the speed of each of the plurality of wheels of the vehicle. The method further includes classifying the roughness of the road based at least in part on the first temporal analysis, the second temporal analysis, and the frequency analysis.

In some examples, performing the first temporal analysis is further based at least in part on longitudinal acceleration data for the vehicle. In some examples, performing the second temporal analysis is further based at least in part on an angular acceleration dispersion of the vehicle. In some examples, performing the second temporal analysis is further based at least in part on an angular dispersion of the vehicle. In some examples, performing the frequency analysis further comprises applying a fast Fourier transform. An example method may additionally include receiving the speed of each of the plurality of wheels from a sensor coupled to each of the plurality of wheels. An example method may additionally include calculating the combined wheel speed of the plurality of wheels based at least in part on the speed of each of the plurality of wheels of the vehicle. An example method may additionally include adjusting a suspension of the vehicle based at least in part on classifying the roughness of the road.

In yet another exemplary embodiment a computer program product for classifying roughness of a road includes a computer readable storage medium having program instructions embodied therewith, wherein the computer readable storage medium is not a transitory signal per se, the program instructions executable by a processing device to cause the processing device to perform a method. In examples, the method includes performing a first temporal analysis based at least in part on a speed of each of a plurality of wheels of a vehicle. The method further includes performing a second temporal analysis based at least in part on a combined wheel speed of the plurality of wheels. The method further includes performing a frequency analysis based at least in part on the speed of each of the plurality of wheels of the vehicle. The method further includes classifying the roughness of the road based at least in part on the first temporal analysis, the second temporal analysis, and the frequency analysis.

In some examples, performing the first temporal analysis is further based at least in part on longitudinal acceleration data for the vehicle. In some examples, performing the second temporal analysis is further based at least in part on an angular acceleration dispersion of the vehicle. In some examples, performing the second temporal analysis is further based at least in part on an angular dispersion of the vehicle. In some examples, performing the frequency analysis further comprises applying a fast Fourier transform. An example method may additionally include receiving the speed of each of the plurality of wheels from a sensor coupled to each of the plurality of wheels. An example method may additionally include calculating the combined wheel speed of the plurality of wheels based at least in part on the speed of each of the plurality of wheels of the vehicle. An example method may additionally include adjusting a suspension of the vehicle based at least in part on classifying the roughness of the road.

The above features and advantages, and other features and advantages, of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 depicts a block diagram of a vehicle including a processing system for classifying roughness of a road, according to embodiments of the present disclosure;

FIG. 2 depicts a flow diagram of a method for classifying roughness of a road, according to aspects of the present disclosure;

FIG. 3 depicts a flow diagram of a method for performing a first temporal analysis, according to aspects of the present disclosure;

FIG. 4 depicts a flow diagram of a method for performing a second temporal analysis, according to aspects of the present disclosure;

FIG. 5 depicts a flow diagram of a method for performing a frequency analysis, according to aspects of the present disclosure;

FIGS. 6A, 6B, and 6C depict road roughness graphs, according to aspects of the present disclosure; and

FIG. 7 depicts a block diagram of a processing system for implementing the techniques described herein, according to aspects of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein provide for classifying roughness of a road using wheel speed of a vehicle traversing the road. More specifically, the present techniques measure wheel speed and use the wheel speed to perform temporal and frequency analyses to classify road roughness. Road roughness can be classified to, for example, adjust a suspension of the vehicle traversing the road to increase ride comfort, maneuverability, safety, efficiency, and other properties of the vehicle.

Existing approaches to road roughness calculation use wheel sensors, but are prone to noise factors such as vehicle variable speed. These existing sensors have low resolution and accuracy, limited operating conditions, require extensive calibration, and provide slow convergence response.

The present techniques use adaptive signal processing and data fusion of existing signals in the vehicle, such as wheel speed signals (both individual and combined speeds) for generating granular estimates of road roughness. The present techniques are more robust to noise factors, such as variable vehicle speeds and provide fast convergence response for high-resolution road classification in a very short period of time. For example, the present techniques can classify smooth and semi-smooth road surfaces in milliseconds to devise control strategies for switchable engine mounts on changing road roughness conditions to improve ride comfort, etc.

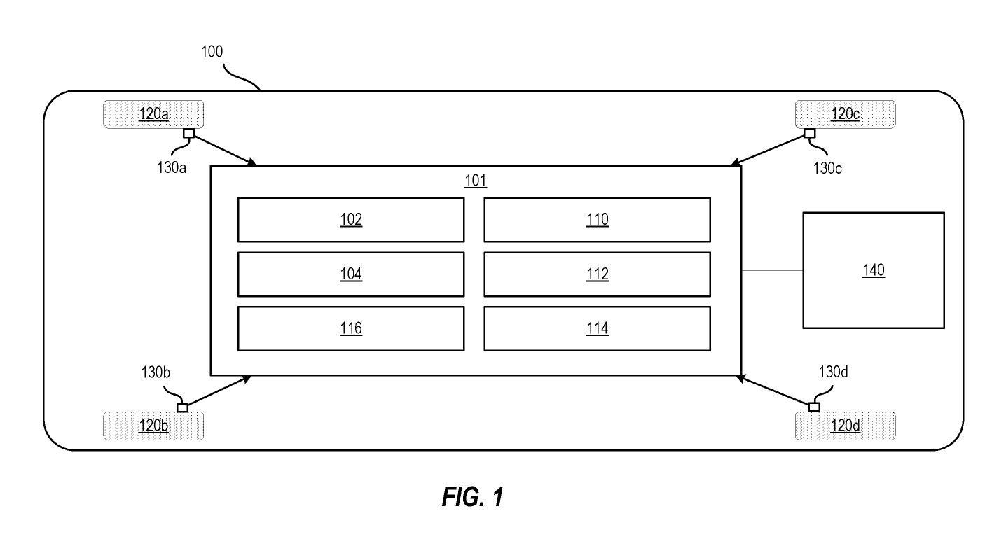

FIG. 1 depicts a vehicle 100 including a processing system 101 for classifying roughness of a road according to embodiments of the present disclosure. The vehicle 100 also includes wheels 120a, 120b, 120c, 120d (collectively “wheels 120”) each having a sensor 130a, 130b, 130c, 130d (collectively “sensors 130”) respectively coupled thereto. The sensors 130 are configured to send data about the wheels 120 to the processing system 101 of the vehicle 100.

The processing system 101 includes a processing device 102, a memory 104, a first temporal analysis engine 110, a second temporal analysis engine 112, a frequency analysis engine 114, and a classification engine 116. The processing system 101 receives data about the wheels 120 (e.g., wheel speed data), and uses the data to perform various temporal and frequency analysis to classify road roughness. Each of these analyses can be used to classify road roughness based on the speed of the wheels (individual and/or collectively), and the results of the analyses can be used together to create a more robust classification of the road roughness.

The various components, modules, engines, etc. described regarding FIG. 1 may be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these.

In examples, the engine(s) described herein may be a combination of hardware and programming. The programming may be processor executable instructions stored on a tangible memory, and the hardware may include the processing device 102 for executing those instructions. Thus a system memory (e.g., the memory 104) can store program instructions that when executed by the processing device 102 implement the engines described herein. Other engines may also be utilized to include other features and functionality described in other examples herein. Alternatively or additionally, the processing system 101 can include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

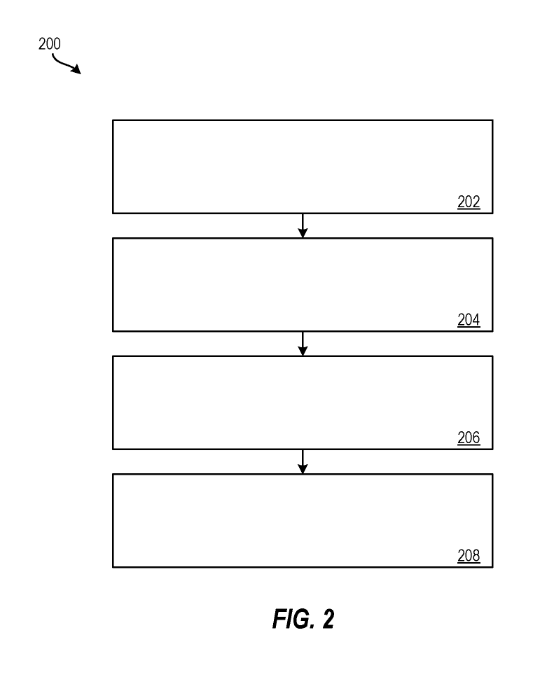

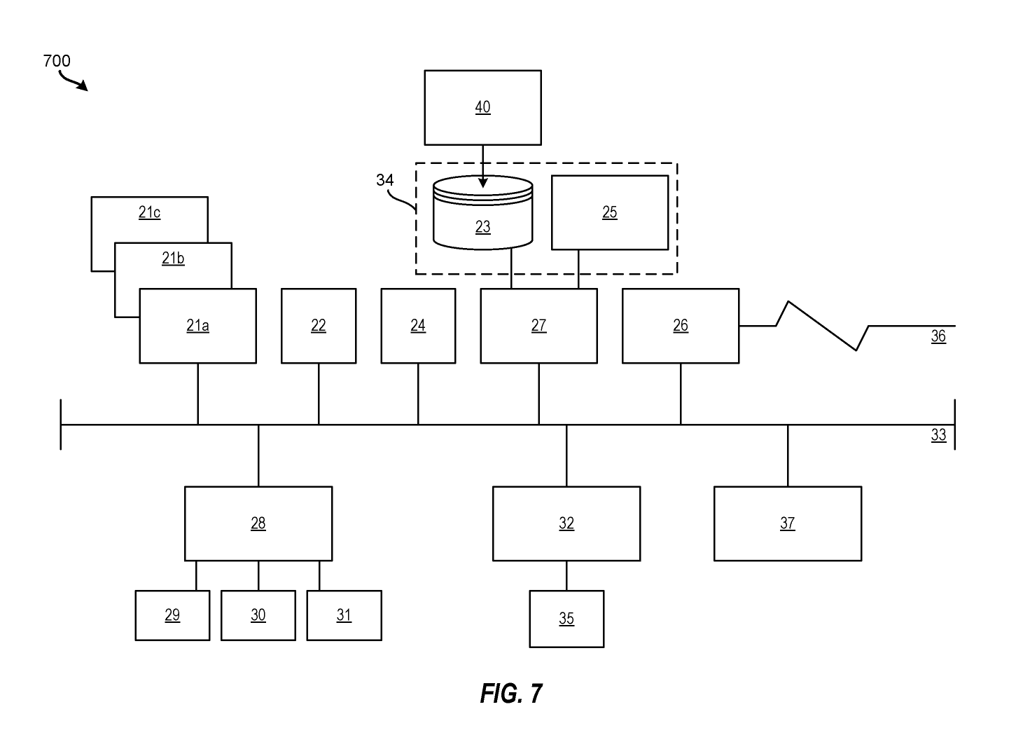

FIG. 2 depicts a flow diagram of a method 200 for classifying roughness of a road according to aspects of the present disclosure. The method 200 may be implemented, for example, by the processing system 101 of FIG. 1, by the processing system 700 of FIG. 7, or by another suitable processing system or device.

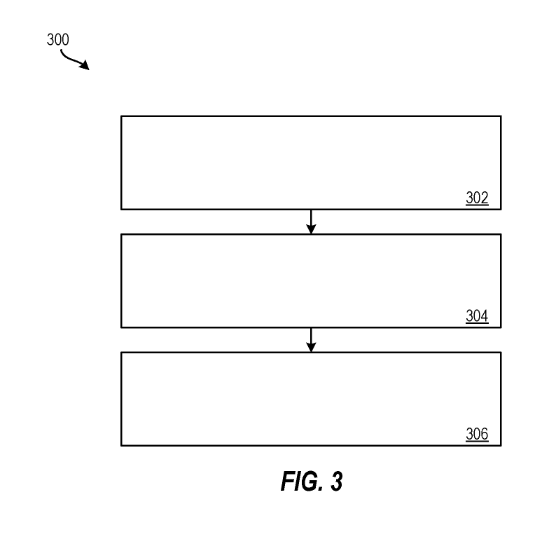

At block 202, the first temporal analysis engine 110 performs a first temporal analysis based at least in part on a speed of each of a plurality of wheels of a vehicle 100. For example, the first temporal analysis engine 110 receives speed data associated with each of the wheels 120 from the respective sensors 130. The first temporal analysis can be performed as described with respect to FIG. 3.

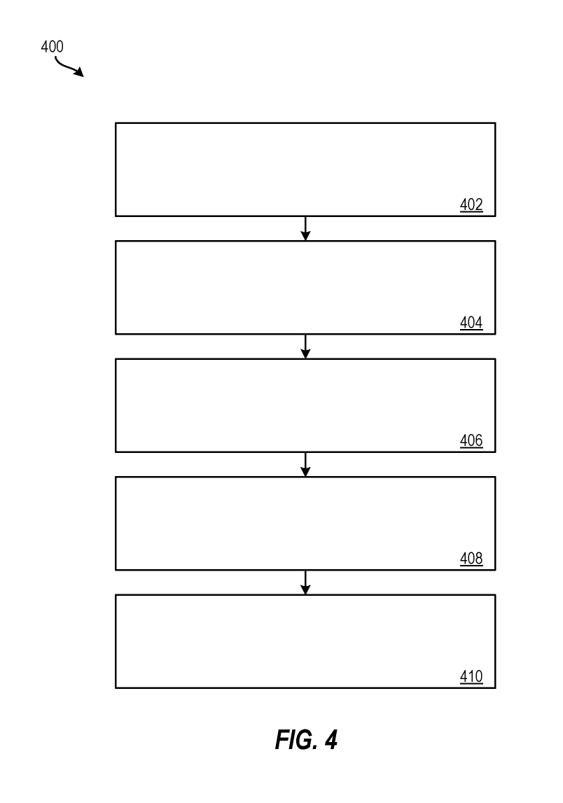

At block 204, the second temporal analysis engine 112 performs a second temporal analysis based at least in part on a combined wheel speed of the plurality of wheels from the respective sensors 130. For example, the second temporal analysis engine 112 receives speed data associated with each of the wheels 120 from the respective sensors 130. The second temporal analysis engine 112 calculates a combined wheel speed of the wheels. The combined wheel speed can be an average of the wheel speeds of each wheel, a sum of the wheel speeds of each wheel, or another suitable indication of the combined wheel speed. The second temporal analysis can be performed as described with respect to FIG. 4.

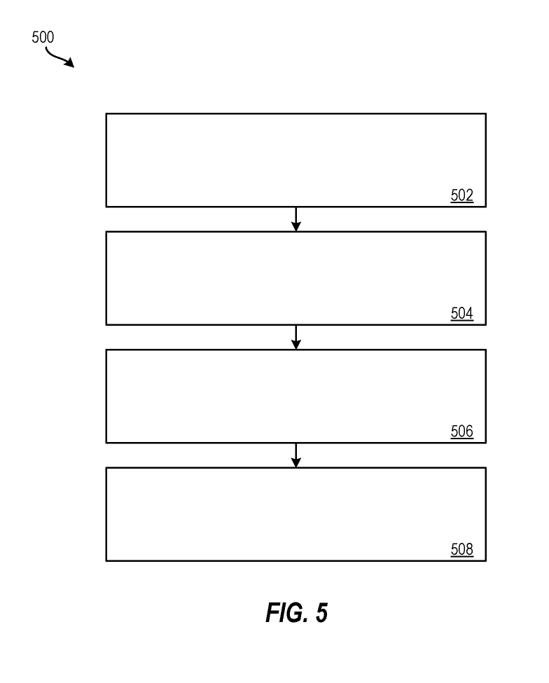

At block 206, the frequency analysis engine 114 performs a frequency analysis based at least in part on the speed of each of the plurality of wheels of the vehicle 100. For example, the frequency analysis engine 114 receives speed data associated with each of the wheels from the respective sensors 130. The frequency analysis can be performed as described with respect to FIG. 5.

At block 208, the classification engine 116 classifies the roughness of the road based at least in part on the first temporal analysis, the second temporal analysis, and the frequency analysis. The road roughness can be classified, for example, as smooth, semi-smooth, semi-rough, rough, etc. The chassis and powertrain adjustment system 140 can adjust a suspension (not shown) of the vehicle 100 based on the roughness classification of the road. The classification engine 116 can classify road roughness in different ways. For example, the classification engine 116 can classify road roughness on a roughness scale of 1-10. In such cases, the chassis and powertrain adjustment system 140 causes the suspension to be in a first mode when the roughness scale is 1-2 or 8-10 and causes the suspension to be in a second mode when the roughness scale is 3-7. It should be appreciated that other classification scoring may be used and that different modes/thresholds can also be used.

In another example, the processing system 101 (or another suitable system) can cause a switchable engine mount (not shown) to switch modes based on the roughness classification. In yet another example, the processing system 101 (or another suitable system) can adjust an anti-lock braking system (ABS) based on the roughness classification. In yet another example, the processing system 101 (or another suitable system) can use the roughness classification to isolate engine misfires by identifying fluctuations/vibrations in a drive train (not shown) of the vehicle 100. For example, fluctuation/vibrations in the drive train on a non-rough road may indicate an engine misfire.

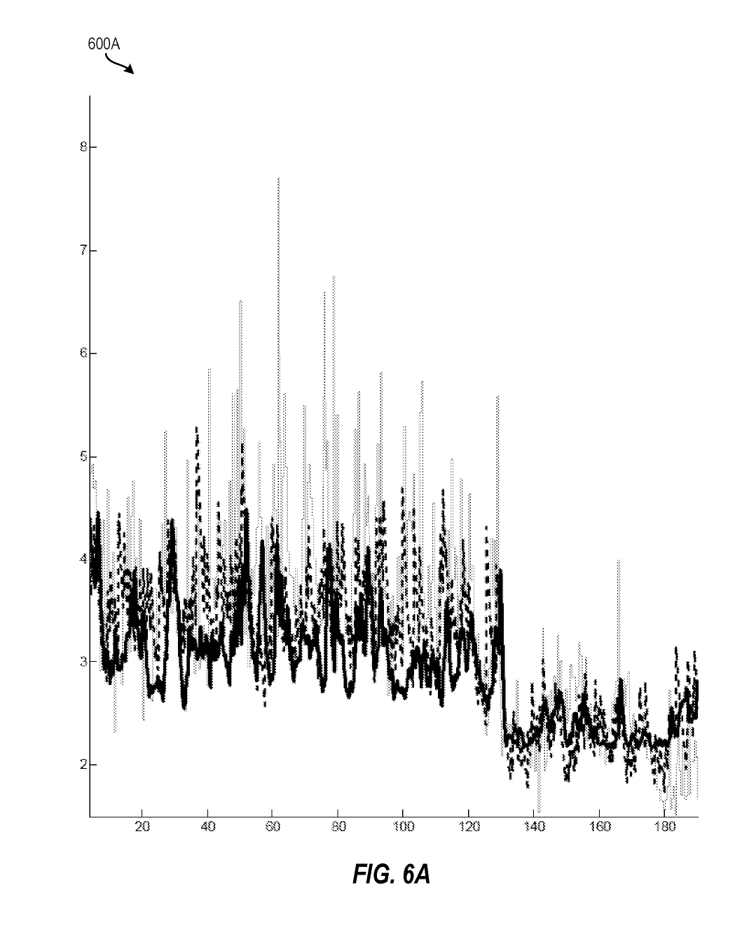

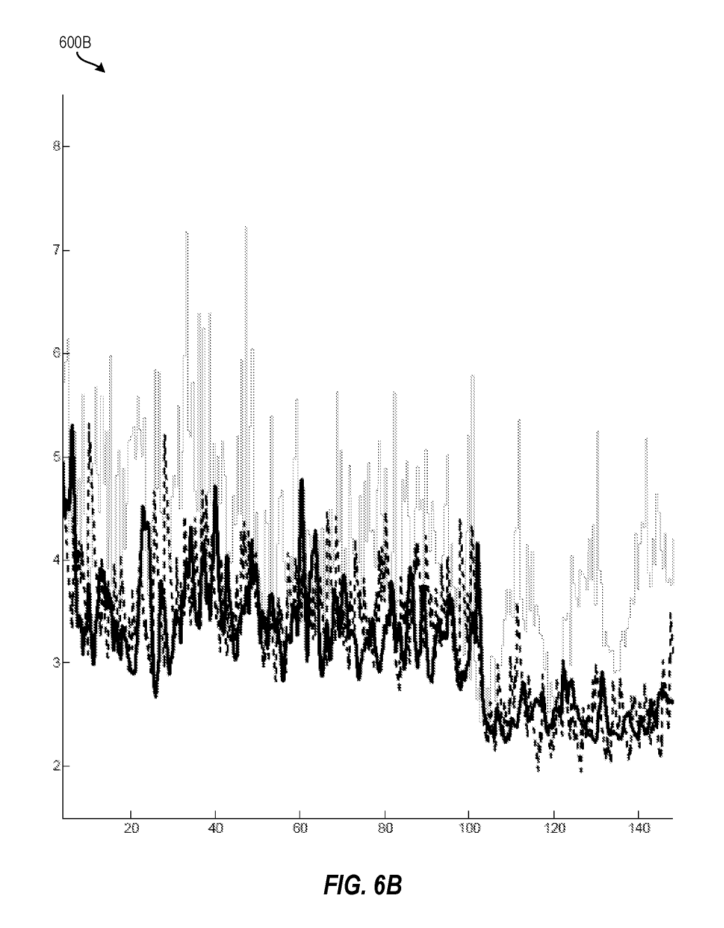

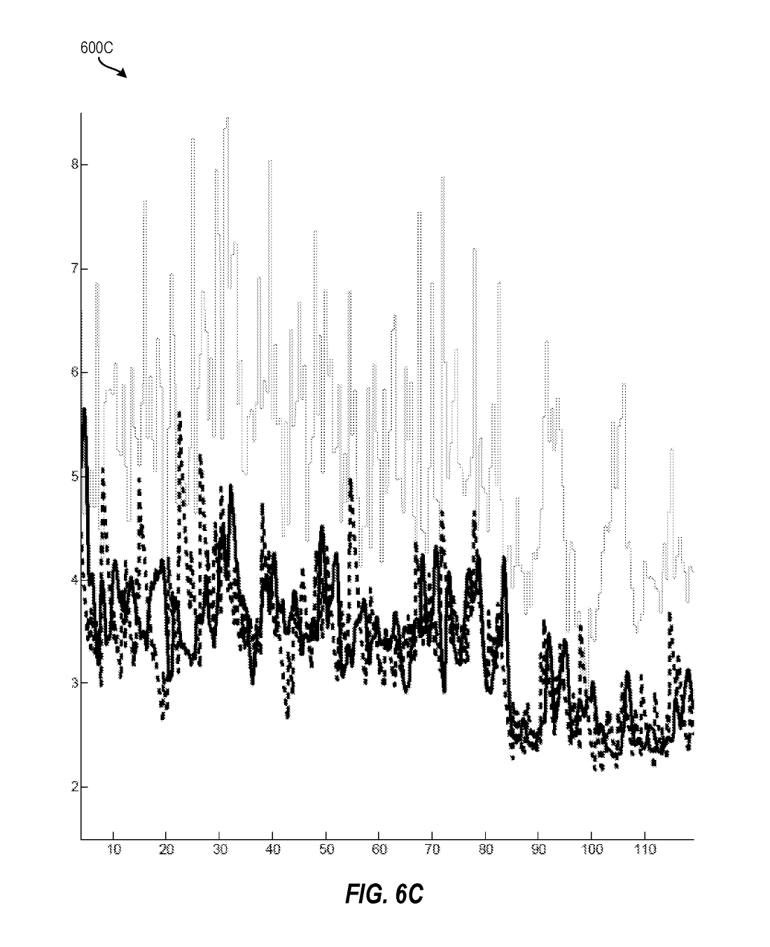

Accordingly, the classification engine 116 provides an estimate of road roughness that is more robust to noise factors, such as vehicle speed and tire parameters, by using the combination of temporal and frequency analyses based on wheel speed data (e.g., individual wheel speed data and/or combined wheel speed data). For example, FIGS. 6A, 6B, and 6C depict road roughness graphs 600A, 600B, and 600C respectively, according to aspects of the present disclosure. The graph 600A depicts a semi-rough to smooth road roughness at 30 miles per hour. The graph 600B depicts a semi-rough to smooth road roughness at 40 miles per hour. The graph 600C depicts a semi-rough to smooth road roughness at 50 miles per hour. The graphs 600A, 600B, 600C plot road roughness against time. The road roughness is represented as signals scaled and biased with the same scale factors for each speed level. The solid line represents road roughness using traditional approaches, the dashed line represents road roughness using the present techniques, and the bold solid line represents accelerometer data as a reference. As is apparent from the graphs 600A, 600B, and 600C, the road roughness classification is more robust to noise factors. For example, as vehicle speed increases (e.g., the graph 600C), prior approaches (i.e., the solid line) are more susceptible to noise influencing road roughness classification than the present techniques (e.g., the dashed line).

Additional processes also may be included, and it should be understood that the processes depicted in FIG. 2 represent illustrations and that other processes may be added or existing processes may be removed, modified, or rearranged without departing from the scope and spirit of the present disclosure.

FIG. 3 depicts a flow diagram of a method 300 for performing a first temporal analysis, according to aspects of the present disclosure. The method 300 may be implemented, for example, by the processing system 101 of FIG. 1, by the processing system 700 of FIG. 7, or by another suitable processing system or device.

At block 302, the first temporal analysis engine 110 fuses wheel speed data with longitudinal acceleration data received, for example, from an inertial measurement unit (not shown). At block 304, the first temporal analysis engine 110 extracts residuals based on expected measurement predictions for the individual wheels. At block 306, the classification engine 116 classifies the roughness of the road based at least in part on the extracted residuals.

Additional processes also may be included, and it should be understood that the processes depicted in FIG. 3 represent illustrations and that other processes may be added or existing processes may be removed, modified, or rearranged without departing from the scope and spirit of the present disclosure.

FIG. 4 depicts a flow diagram of a method 400 for performing a second temporal analysis, according to aspects of the present disclosure. The method 400 may be implemented, for example, by the processing system 101 of FIG. 1, by the processing system 700 of FIG. 7, or by another suitable processing system or device.

At block 402, the second temporal analysis engine 112 calculates an angular acceleration dispersion of the vehicle 100. At block 404, the second temporal analysis engine 112 calculates a combined wheel angular acceleration dispersion for the vehicle 100. At block 406, the second temporal analysis engine 112 filters the angular acceleration dispersion, for example, to remove angular dispersion jerk. At block 408, the second temporal analysis engine 112 extracts residuals based on expected measurement predictions for the wheels based on the combined wheel speed of the wheels. At block 410, the classification engine 116 classifies the roughness of the road based at least in part on the extracted residuals.

Additional processes also may be included, and it should be understood that the processes depicted in FIG. 4 represent illustrations and that other processes may be added or existing processes may be removed, modified, or rearranged without departing from the scope and spirit of the present disclosure.

FIG. 5 depicts a flow diagram of a method 500 for performing a frequency analysis, according to aspects of the present disclosure. The method 500 may be implemented, for example, by the processing system 101 of FIG. 1, by the processing system 700 of FIG. 7, or by another suitable processing system or device.

At block 502, the frequency analysis engine 114 applies a fast Fourier transform (FFT) to the speed of each of the wheels of the vehicle 100. At block 504, the frequency analysis engine 114 filters the results of the FFT by frequency response, for example, by using a band pass filter, to identify specific energy bands (e.g., to filter different vehicle speeds). At block 506, the frequency analysis engine 114 processes the filtered data to determine a power spectral density for the wheel speed of each wheel. At block 508, the classification engine 116 classifies the roughness of the road based at least in part on the power spectral density.

Additional processes also may be included, and it should be understood that the processes depicted in FIG. 5 represent illustrations and that other processes may be added or existing processes may be removed, modified, or rearranged without departing from the scope and spirit of the present disclosure.

It is understood that the present disclosure is capable of being implemented in conjunction with any other type of computing environment now known or later developed. For example, FIG. 7 illustrates a block diagram of a processing system 700 for implementing the techniques described herein. In examples, processing system 700 has one or more central processing units (processors) 21a, 21b, 21c, etc. (collectively or generically referred to as processor(s) 21 and/or as processing device(s)). In aspects of the present disclosure, each processor 21 may include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and may include a basic input/output system (BIOS), which controls certain basic functions of processing system 700.

Further illustrated are an input/output (I/O) adapter 27 and a network adapter 26 coupled to system bus 33. I/O adapter 27 may be a small computer system interface (SCSI) adapter that communicates with a hard disk 23 and/or another storage drive 25 or any other similar component. I/O adapter 27, hard disk 23, and storage device 25 are collectively referred to herein as mass storage 34. Operating system 40 for execution on processing system 700 may be stored in mass storage 34. A network adapter 26 interconnects system bus 33 with an outside network 36 enabling processing system 700 to communicate with other such systems.

A display (e.g., a display monitor) 35 is connected to system bus 33 by display adapter 32, which may include a graphics adapter to improve the performance of graphics intensive applications and a video controller. In one aspect of the present disclosure, adapters 26, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit.

In some aspects of the present disclosure, processing system 700 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 700 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system to coordinate the functions of the various components shown in processing system 700.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present techniques not be limited to the particular embodiments disclosed, but will include all embodiments falling within the scope of the application.

What is claimed is:

1. A computer-implemented method for classifying roughness of a road, the method comprising:
performing, by a processing device, a first temporal analysis based at least in part on a speed of each of a plurality of wheels of a vehicle;
performing, by the processing device, a second temporal analysis based at least in part on a combined wheel speed of the plurality of wheels;
performing, by the processing device, a frequency analysis based at least in part on the speed of each of the plurality of wheels of the vehicle; and
classifying, by the processing device, the roughness of the road based at least in part on the first temporal analysis, the second temporal analysis, and the frequency analysis.

2. The computer-implemented method of claim 1, wherein performing the first temporal analysis is further based at least in part on longitudinal acceleration data for the vehicle.

3. The computer-implemented method of claim 1, wherein performing the second temporal analysis is further based at least in part on an angular acceleration dispersion of the vehicle wheels.

4. The computer-implemented method of claim 1, wherein performing the second temporal analysis is further based at least in part on a filtered angular dispersion of the vehicle wheels.

5. The computer-implemented method of claim 1, wherein performing the frequency analysis further comprises applying a fast Fourier transform.

6. The computer-implemented method of claim 1, further comprising receiving the speed of each of the plurality of wheels from a sensor coupled to each of the plurality of wheels.

7. The computer-implemented method of claim 1, further comprising calculating the combined wheel speed of the plurality of wheels based at least in part on the speed of each of the plurality of wheels of the vehicle.

8. The computer-implemented method of claim 1, further comprising adjusting a chassis and powertrain of the vehicle based at least in part on classifying the roughness of the road.

9. A system for classifying roughness of a road, the system comprising:
a memory comprising computer readable instructions; and
a processing device for executing the computer readable instructions for performing a method, the method comprising:
performing, by the processing device, a first temporal analysis based at least in part on a speed of each of a plurality of wheels of a vehicle;
performing, by the processing device, a second temporal analysis based at least in part on a combined wheel speed of the plurality of wheels;
performing, by the processing device, a frequency analysis based at least in part on the speed of each of the plurality of wheels of the vehicle; and
classifying, by the processing device, the roughness of the road based at least in part on the first temporal analysis, the second temporal analysis, and the frequency analysis.

10. The system of claim 9, wherein performing the first temporal analysis is further based at least in part on longitudinal acceleration data for the vehicle.

11. The system of claim 9, wherein performing the second temporal analysis is further based at least in part on an angular acceleration dispersion of the vehicle wheels.

12. The system of claim 9, wherein performing the second temporal analysis is further based at least in part on a filtered angular dispersion of the vehicle wheels.

13. The system of claim 9, wherein performing the frequency analysis further comprises applying a fast Fourier transform.

14. The system of claim 9, wherein the method further comprises receiving the speed of each of the plurality of wheels from a sensor coupled to each of the plurality of wheels.

15. The system of claim 9, wherein the method further comprises calculating the combined wheel speed of the plurality of wheels based at least in part on the speed of each of the plurality of wheels of the vehicle.

16. The system of claim 9, wherein the method further comprises adjusting a chassis and powertrain of the vehicle based at least in part on classifying the roughness of the road.

17. A computer program product for classifying roughness of a road, the computer program product comprising:
a computer readable storage medium having program instructions embodied therewith, wherein the computer readable storage medium is not a transitory signal per se, the program instructions executable by a processing device to cause the processing device to perform a method comprising:
performing, by the processing device, a first temporal analysis based at least in part on a speed of each of a plurality of wheels of a vehicle;
performing, by the processing device, a second temporal analysis based at least in part on a combined wheel speed of the plurality of wheels;
performing, by the processing device, a frequency analysis based at least in part on the speed of each of the plurality of wheels of the vehicle; and
classifying, by the processing device, the roughness of the road based at least in part on the first temporal analysis, the second temporal analysis, and the frequency analysis.

18. The computer program product of claim 17, wherein the method further comprises receiving the speed of each of the plurality of wheels from a sensor coupled to each of the plurality of wheels.

19. The computer program product of claim 17, wherein the method further comprises calculating the combined wheel speed of the plurality of wheels based at least in part on the speed of each of the plurality of wheels of the vehicle.

20. The computer program product of claim 17, wherein the method further comprises adjusting a chassis and powertrain of the vehicle based at least in part on classifying the roughness of the road.
